(19) United States
(12) Patent Application Publication
(10) Pub. No.: US 2006/0283274 A1
(43) Pub. Date: Dec. 21, 2006

(54) Transmission mechanism for ornaments

(76) Inventor: Lieh-Liang Hsu, (US)

Correspondence Address: HDSL, 4331 STEVENS BATTLE LANE, FAIRFAX, VA, 22033, US

(21) Appl. No.: 11/152,168

(22) Filed: Jun. 15, 2005

(51) Int. Cl. F16H 21/18

(52) U.S. Cl. 74/55; 74/49

(57) ABSTRACT

A transmission mechanism for an ornament includes a base assembly, a motor, and a guiding device. The base assembly includes a housing. The motor is mounted on the housing. An eccentric gear is connected to the motor. The guiding device includes a guiding bracket and a slide board movably coupled to the guiding bracket. The bracket is fixed to the housing. A through hole is defined in the slide board for receiving the eccentric gear. A transmission member is disposed at the top of the slide board.

### BACKGROUND OF THE INVENTION

The present invention relates to a transmission mechanism, and particularly to a transmission mechanism for an ornament.

Many kinds of ornaments can perform a predetermined cyclical motion respectively, which makes the ornaments lovely and attractive. In general, each ornament includes a transmission mechanism disposed therein for connecting with desired movable components of the ornament thereby performing the cyclical motion. For example, an eagle ornament has a pair of wings connecting with a transmission mechanism disposed in the ornament whereby the eagle can swing mimically.

However, the transmission mechanism is easy to have some trouble which causes rough and unstable transmission. Or the transmission mechanism is complicated and is not applicable to different kinds of ornaments with different sizes.

### SUMMARY OF THE INVENTION

Accordingly, the present invention is to provide a transmission mechanism for an ornament which is simple for facilitating to use in different applications and can reduce transmission resistance for achieving smooth transmission thereby increasing working stability and expectancy of life of the ornament.

The transmission mechanism for an ornament in accordance with the present invention includes a base assembly, a motor, and a guiding device. The base assembly includes a housing. The motor is mounted on the housing. An eccentric gear is connected to the motor. The guiding device includes a guiding bracket and a slide board movably coupled to the guiding bracket. The bracket is fixed to the housing. A through hole is defined in the slide board for receiving the eccentric gear. A transmission member is disposed at the top of the slide board.

Furthermore, A plurality of screw posts are disposed at the housing for fixing the motor. A power chamber is defined in the bottom of the housing for connecting with a battery or a power connector thereby providing power to the motor. The guiding bracket is integral with the housing. A pair of guiding grooves is symmetrically defined in the guiding bracket for receiving the slide board therebetween. A pair of guiding grooves is defined in opposite side edges of the slide board for receiving the guiding bracket therein. The through hole is elliptical. A push board is disposed at the top end of the slide board, and a through opening is defined in the push board. The transmission member is a hollow can and threadedly fixed at the push board for moving with the slide board, and a lighting member is further disposed in the transmission member. A sleeve is received in the transmission member.

Other objects, advantages and novel features of the present invention will be drawn from the following detailed embodiment of the present invention with attached drawings, in which:

### BRIEF DESCRIPTION OF THE DRAWINGS

FIG. 1 is an exploded view of a transmission mechanism for an ornament of the present invention;

FIG. 2 is a partially assembled and cross-sectional view of FIG. 1;

FIG. 2A is a partially assembled and side elevational view of FIG. 1;

FIG. 3 is an assembled view of FIG. 1 showing working status of the transmission mechanism;

FIG. 3A is an enlarged view of a circled portion A in FIG. 3;

FIG. 4 is a perspective view showing the transmission mechanism being applied in an eagle ornament;

FIG. 5 is an exploded view showing a pair of wings to connect a sleeve of the transmission mechanism.

### DESCRIPTION OF THE PREFERRED EMBODIMENT

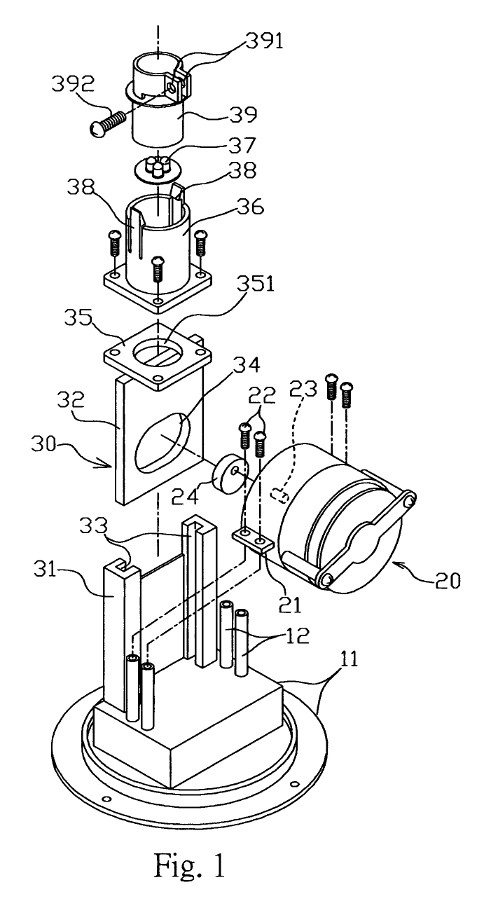

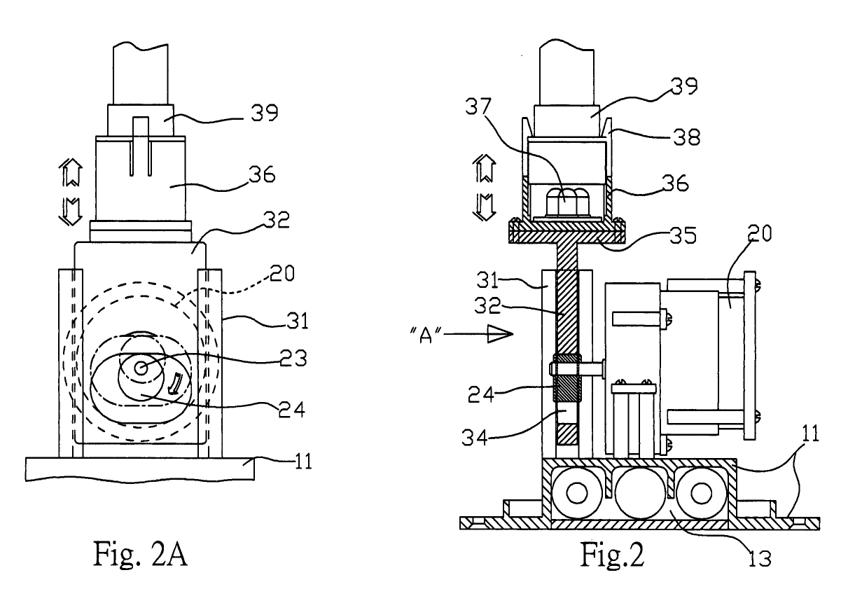

Referring to FIGS. 1-2, a transmission mechanism for an ornament of the present invention includes a base assembly 10, a motor 20, and a guiding device 30. The base assembly 10 includes a housing 11. A plurality of screw posts 12 is disposed at the housing 11. A power chamber 13 is defined in the bottom of the housing 11 for connecting with a battery or a power connector thereby providing power to the motor 20. The motor 20 is mounted on the housing 11. In this embodiment, a positioning plate 21 is disposed at the motor 20 and is threadedly fixed to the screw posts 12 through screws 22. A rotating shaft 23 extends from the motor 20. An eccentric gear 24 is attached to the rotating shaft 23 and so rotates with the rotating shaft 23.

The guiding device 30 includes a guiding bracket 31 and a slide board 32 movably coupled to the guiding bracket 31. The bracket 31 is fixed to the housing 11 or is integral with the housing 11. A pair of guiding grooves 33 is symmetrically defined in the guiding bracket 31. The slide board 32 is received between the guiding grooves 33. A through hole 34 is defined in the slide board 32 for receiving the eccentric gear 24 or is actuated by the eccentric gear 24. The through hole 34 is preferably elliptical. A push board 35 is disposed at the top end of the slide board 32. A through opening 351 is defined in the push board 35 for facilitating extension of a power line. A transmission member 36 is disposed at the top of the slide board 32. In this embodiment, the transmission member 36 is a hollow can and threadedly fixed at the push board 35 for moving with the slide board 32. A lighting member 37, such as an LED, is further disposed in the transmission member 36 for a desired lighting effect. A pair of clips 38 is further disposed at the opposite sides of the transmission member 36. A sleeve 39 is received in the transmission member 36 and is clipped by the clips 38. An open ring 391 is disposed at the top end of the sleeve 39. A bolt 392 is connected to the open ring 391 for adjusting the open ring 391 to connect with a complementary component.

When the motor 20 operates, the eccentric gear 24 actuates the slide board 32 to move up and down along the guiding grooves 33 of the guiding bracket 31. Thus, the transmission member 36 and the sleeve 39 are moved up and down.

The guiding bracket 31 is used to support the slide board 32 guide the slide board 32 to move therealong. As an alternative embodiment, the guiding grooves 33 may be disposed at the opposite side edges of the slide board 31 and the guiding bracket 31 is board-shaped and is received in the guiding grooves 33.

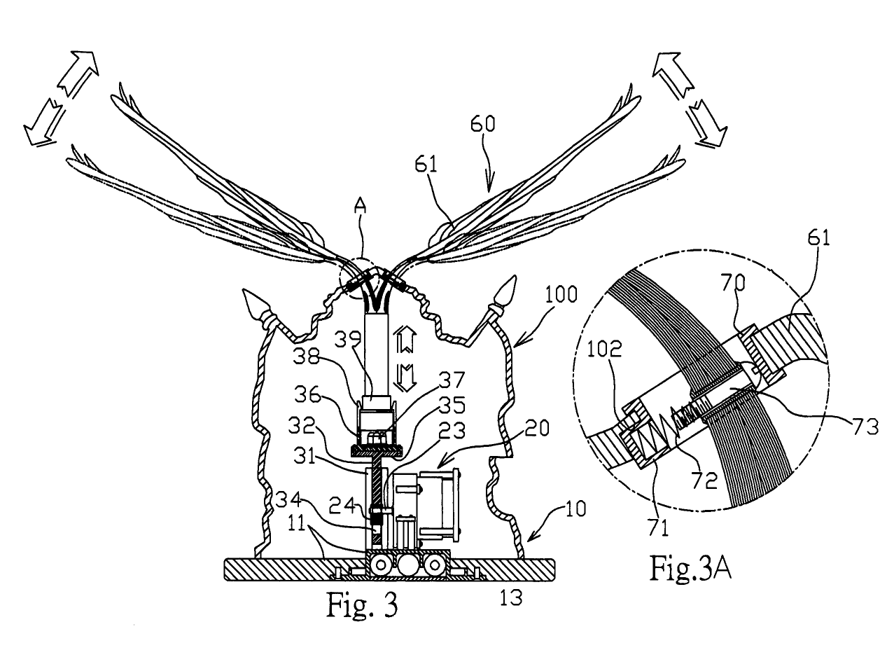

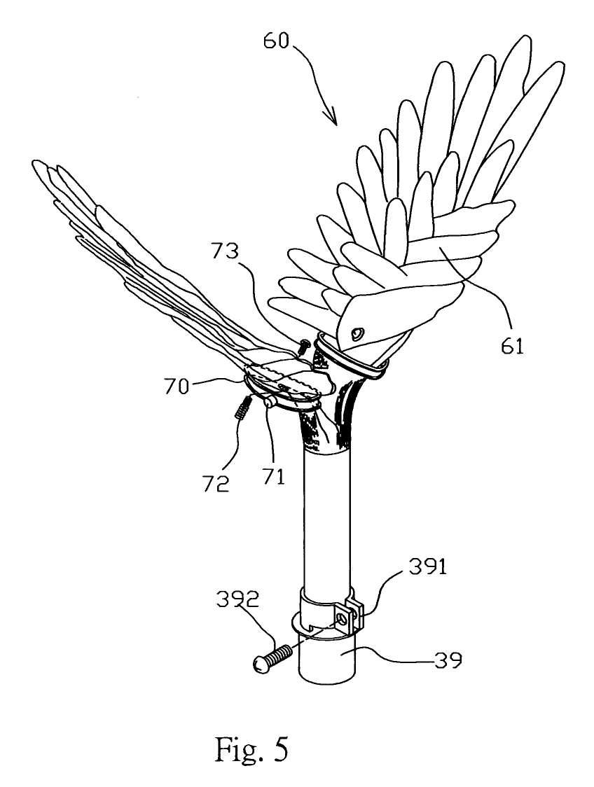

Referring to FIGS. 3-5, the transmission mechanism of the present invention is applied to an eagle ornament which includes a body 100 receiving the transmission mechanism. A pair of wings 60 is disposed at the body 100. One end of each wing 60 is fixed in the sleeves 39. The sleeves 39 is inserted into the transmission member 36 thereby facilitating to assemble the wings 60.

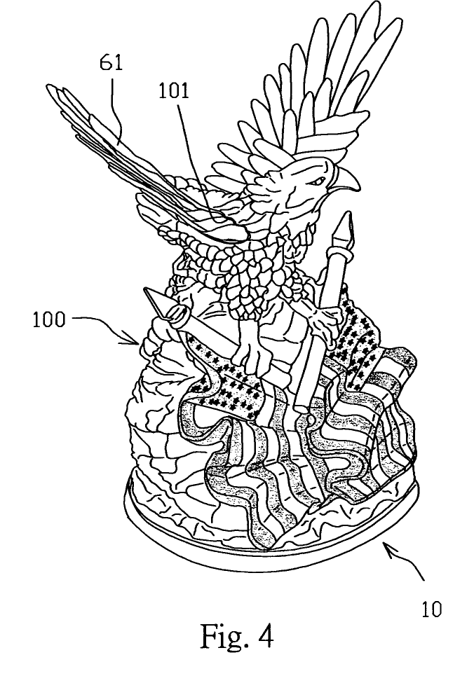

The wings 60 includes right and left parts 61. Each part 61 extends from a through aperture 101 defined in the body 100. A cannula 70 is disposed at the part 61. A protrusion 71 extends from the cannula 70 for engaging with a positioning hole 102 defined in the body 100. The cannula further includes a spring 72 and a bolt 73 connected with the corresponding part 61. Therefore, when the wings 60 are actuated by the slide board 32 to move up and down, the right and left parts 61 swing up and down. That's, the wings 60 look to fly (see FIG. 4) thereby increasing the dynamic decorative effect.

As mentioned above, the transmission mechanism for an ornament of the present invention is simple for facilitating to use in different applications and can reduce transmission resistance for achieving smooth transmission thereby increasing working stability and expectancy of life of the ornament.

It is understood that the invention may be embodied in other forms without departing from the spirit thereof. Thus, the present example and embodiment are to be considered in all respects as illustrative and not restrictive, and the invention is not to be limited to the details given herein.

I claim:

1. A transmission mechanism for an ornament comprising a base assembly, a motor, and a guiding device, the base assembly comprising a housing, the motor being mounted on the housing, an eccentric gear being connected to the motor, the guiding device comprising a guiding bracket and a slide board movably coupled to the guiding bracket, the bracket being fixed to the housing, a through hole being defined in the slide board for receiving the eccentric gear, a transmission member being disposed at the top of the slide board.

2. The transmission mechanism as claimed in claim 1, wherein a plurality of screw posts is disposed at the housing for fixing the motor.

3. The transmission mechanism as claimed in claim 1, wherein a power chamber is defined in the bottom of the housing for connecting with a battery or a power connector thereby providing power to the motor.

4. The transmission mechanism as claimed in claim 1, wherein the guiding bracket is integral with the housing.

5. The transmission mechanism as claimed in claim 1, wherein a pair of guiding grooves is symmetrically defined in the guiding bracket for receiving the slide board therebetween.

6. The transmission mechanism as claimed in claim 1, wherein a pair of guiding grooves is defined in opposite side edges of the slide board for receiving the guiding bracket therein.

7. The transmission mechanism as claimed in claim 1, wherein the through hole is elliptical.

8. The transmission mechanism as claimed in claim 1, wherein a push board is disposed at the top end of the slide board, and a through opening is defined in the push board.

9. The transmission mechanism as claimed in claim 8, wherein the transmission member is a hollow can and threadedly fixed at the push board for moving with the slide board, and a lighting member is further disposed in the transmission member.

10. The transmission mechanism as claimed in claim 8, wherein a sleeve is received in the transmission member.
